(19) United States
(12) Patent Application Publication
(10) Pub. No.: US 2008/0157926 A1
(43) Pub. Date: Jul. 3, 2008

(54) Radiofrequency identification and analysis

(76) Inventors: Richard P. Maguire, Albuquerque, NM (US); Robert L. Vaughn, Albuquerque, NM (US); Andrew J. Schiestl, Rio Rancho, NM (US)

Correspondence Address: INTEL/BLAKELY, 1279 OAKMEAD PARKWAY, SUNNYVALE, CA, 94085-4040, US

(21) Appl. No.: 11/647,658

(22) Filed: Dec. 28, 2006

(51) Int. Cl. H04Q 5/22

(52) U.S. Cl. 340/10.1

(57) ABSTRACT

Methods of radiofrequency identification and analysis are disclosed. In one aspect, a method may include transmitting a wireless interrogation signal. Corresponding wireless response signals may be received from each of a plurality of transponders. Then, analysis of interrelationships between different types of objects each associated with one of the transponders may be performed. Software and apparatus to perform such methods are also disclosed. In another aspect, a method of radiofrequency identification may include accessing additional information about one or more objects that are each associated with a different one of the transponders from a peripheral database.

### BACKGROUND

1. Field

Embodiments of the invention relate to the field of radiofrequency identification.

2. Background Information

Various radiofrequency identification (RFID) tags and readers therefor are known in the arts. The RFID tags are commonly attached to goods and products in the marketplace. The use of the RFID tags tends to be predominantly for purposes of rapid and efficient identification and inventorying of the goods and products. The amount of information available from RFID tags tends to be quite limited.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is a block diagram of a radiofrequency identification and analysis system, according to one or more embodiments of the invention.

FIG. 2 is a block flow diagram of a method of analyzing interrelationships between objects associated with transponders, according to one or more embodiments of the invention.

FIG. 3 is a block diagram of a radiofrequency identification system having a peripheral database that is accessible by the reader device, according to one or more embodiments of the invention.

FIG. 4 is a block flow diagram of a method of a reader device obtaining or accessing additional potentially detailed information about one or more objects, according to one or more embodiments of the invention.

FIG. 5 is a block diagram of a radiofrequency identification system having an object that is capable of communicating with a peripheral database, according to one or more embodiments of the invention.

FIG. 6 is a simplified block flow diagram of an example reader device, according to one or more embodiments of the invention.

FIG. 7 is a block diagram of a program product or other article of manufacture, according to one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

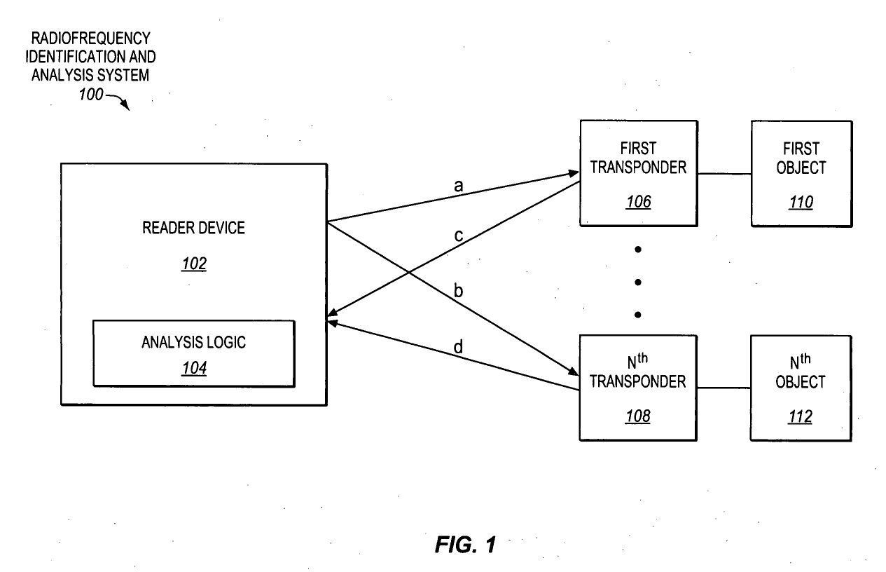

FIG. 1 is a block diagram of a radiofrequency identification and analysis system 100, according to one or more embodiments of the invention. This system includes a reader device 102 having analysis logic 104. The analysis logic will be discussed further below.

The reader device may represent an electronic device having an antenna that is capable of transmitting a radiofrequency electromagnetic field or wireless signal known as an interrogation signal a, b to transponders, and receiving corresponding wireless response signals c, d including identification and potentially a limited amount of static data (e.g., object type, manufacture date, etc.) from the transponders. Retrieving the identification and data from the transponders is sometimes referred to in the arts as reading. The reader device is also sometimes referred to in the arts as an interrogation device, a scanner, or simply a transceiver.

Various form factors of the reader device are possible. Examples of suitable form factors for the reader device include, but are not limited to, personal digital assistants (PDAs), laptops, electronic clinical notebooks, desktop computers, and those of other known wireless computing devices having one or more processors. Often, the device is small and portable, although the scope of the invention is not so limited.

The system also includes a plurality of transponders or TRANSmitters/resPONDERS 106, 108. In the illustrated embodiment, the plurality of transponders include a first transponder 106, and an Nth transponder 108, where N may represent an integer often ranging from 2 to an arbitrarily large number.

The transponders may each include a device that may receive the wireless interrogation signal a, b from the reader device, and transmit a respective wireless response signal c, d including identification and potentially data back to the reader device. In some cases, the transponders may automatically transmit predetermined potentially amplified response signals upon receiving a predetermined interrogation signal. Examples of suitable transponders include, but are not limited to, radiofrequency (RF) tags, such as, for example, radiofrequency identification (RFID) tags, electronic labels, and other types of transponders known in the arts. RF tags and RFID tags are sometimes referred to in the arts simply as tags.

The system also includes a plurality of objects 110, 112. Each of the objects is associated with a respective one of the transponders. In particular, a first object 110 is associated with the first transponder, and an Nth object 112 is associated with the Nth transponder.

The scope of the invention is not limited to any known type of object. Examples of suitable objects that may be tagged include, but are not limited to, manufactured devices or other products (e.g., microelectronic devices, electronic devices, computers, cell phones, televisions, books, pharmaceuticals, etc.), manufacturing tools and materials (e.g., semiconductor manufacturing tools, chemical containers, etc.), tools and instruments of use (e.g., medical tools and instruments used to perform medical procedures, semiconductor manufacturing tools), animals (e.g., livestock, zoo animals), persons (e.g., patients, employees), and the like, and combinations thereof. A wide variety of other objects that have heretofore been tagged with RFID tags also represent suitable objects.

In one or more embodiments, the set of objects may include a diverse set of objects of different types. As one example, the set of objects may include different types of medical tools used to perform a medical procedure or to be found in a properly stocked emergency room or ambulance. As another example, the set of objects may include different types of equipment, tools, materials, chemicals, and other manufacturing objects used to manufacture products, such as, for example, microelectronic devices, or otherwise desired to be found in a properly stocked manufacturing setting or facility. As yet another example, the set of objects may include both objects that are permanently with an environment (e.g., a properly stocked emergency room or ambulance) as well as objects that enter and/or exit the environment on a temporary basis (e.g., medical instruments carried by a doctor or nurse).

Referring again to FIG. 1, the reader device includes the analysis logic 104. The analysis logic may perform analysis based, at least in part, on the wireless responses from the transponders. The analysis is not limited to simple object identification and inventorying. Rather, the analysis may analyze mutual relationships or interrelationships between different objects that are each associated with one of the transponders that responded to the interrogation signal, as will be discussed further below.

In one or more embodiments of the invention, the analysis logic may include software, such as, for example, machine-executable instructions. As another option, in one or more embodiments, the analysis logic may include hardware, such as, for example, one or more microelectronic devices or other circuits. As yet another option, in one or more embodiments, the analysis logic may include a combination of software and hardware.

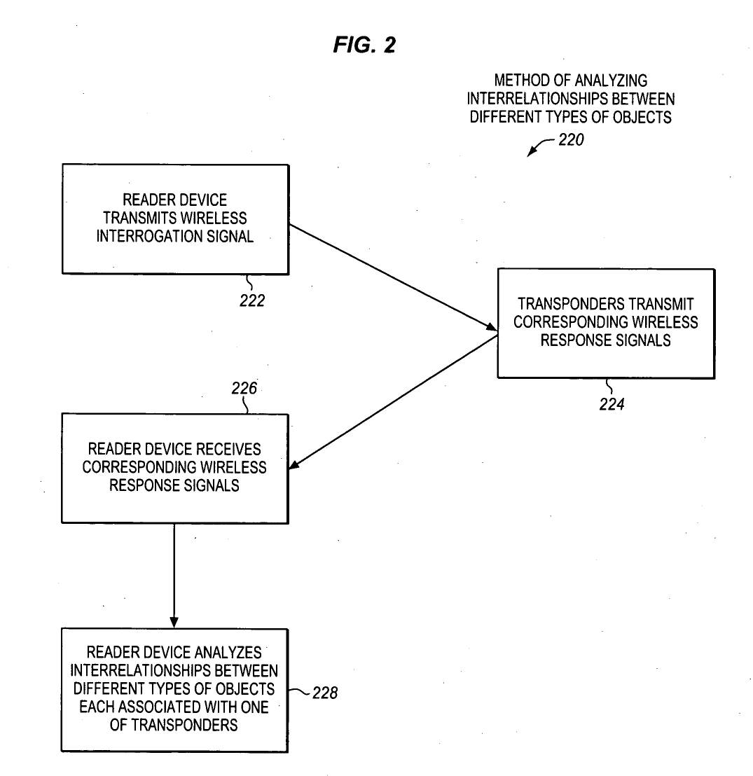

FIG. 2 is a block flow diagram of a method 220 of analyzing interrelationships between objects associated with transponders, according to one or more embodiments of the invention.

As previously mentioned, the reader device may transmit a wireless interrogation signal, at block 222. Transponders in sufficient proximity to receive the wireless interrogation signal may respond by transmitting corresponding wireless response signals, at block 224. Then, the reader device may receive the corresponding wireless response signals, at block 226.

At block 228, the reader device may perform an analysis based, at least in part, on the wireless response signals from the transponders. As shown, in one or more embodiment of the invention, the reader device may analyze mutual relationships or interrelationships between different types of objects that are each associated with one of the transponders that responded to the interrogation signal.

The analysis of the interrelationships may be based, at least in part, on known differences of the characteristics of the objects and known rules or processing instructions regarding these differences. In one or more embodiments of the invention, the analysis may involve the application of in-depth business logic in order to make determinations about a plurality of objects that responded or the set of responding objects as a whole. The in-depth business logic may include evaluating or applying conditional statements, constraints, equations, rules, heuristics, and the like, and combinations thereof.

A wide variety of different types of analysis are contemplated. To further illustrate, consider the following illustrative examples.

In one or more embodiments of the invention, analyzing the interrelationships between the different types of objects may include analyzing mutual compatibilities of the different types of objects. Certain objects may be compatible, whereas other objects may not be compatible, or at least may be insufficiently compatible for the particular implementation. By way of example, certain chemicals or other materials may have dangerous or otherwise incompatible chemical interactions. For example, certain materials if combined may participate in chemical reactions that may lead to explosions, generation of noxious or poisonous gases, or other undesirable or potentially hazardous effects. As another example, in a hospital setting, used medical equipment that has not yet been sterilized may be incompatible with clean and properly sterilized medical equipment and may deserve separation and proper sterilization prior to starting a medical procedure. Other types of compatibility are also contemplated. Advantageously, in one or more embodiments of the invention, analysis as disclosed herein may be used to analyze the mutual compatibilities of a plurality of the different types of objects in an environment or interrogator read zone to determine whether or not a potentially dangerous, hazardous, or otherwise undesirable condition may exist.

In one or more embodiments of the invention, analyzing the interrelationships between the different types of objects may include analyzing for sufficiency of the different types of objects to complete a given task. Certain combinations may be sufficient to complete or accomplish a task, whereas other combinations or subsets of a needed combination, may be insufficient to complete or accomplish the task. For example, in order to perform a medical operation or other procedure, certain tools, instruments, or the like, may be needed in the room. As another example, in order to manufacture a product, such as, for example, an integrated circuit, certain equipment, starting materials, or the like, may be needed in the area. As yet another example, in order to provide emergency response in a disaster area, certain supplies may be needed and it may further be desirable to know what supplies are available. Advantageously, in one or more embodiments of the invention, analysis as disclosed herein may be used to analyze a plurality of the different types of objects in an environment or interrogator read zone for sufficiency to complete or accomplish a task. This may allow rapidly. determining whether or not the current set is sufficient or if one or more missing, turned off, improperly maintained, improperly sterilized, or otherwise unavailable objects need to be obtained or readied.

Other types of analysis are also contemplated. For example, analysis may be used to determine whether objects are compatible with their environment. As another example, analysis may be used to determine whether objects are up to date on their maintenance schedule.

These are just a few illustrative examples. Many other examples will be apparent to those skilled in the art and having the benefit of the present disclosure. As should readily be apparent, a wide variety of different types of analysis may be performed depending upon the particular implementation.

In one or more embodiments of the invention, the analysis may be used to make a determination. For example, the determination may be that a potentially dangerous situation exists. In one or more embodiments of the invention, a result of the analysis or a determination may be displayed or otherwise presented to the user of the reader device.

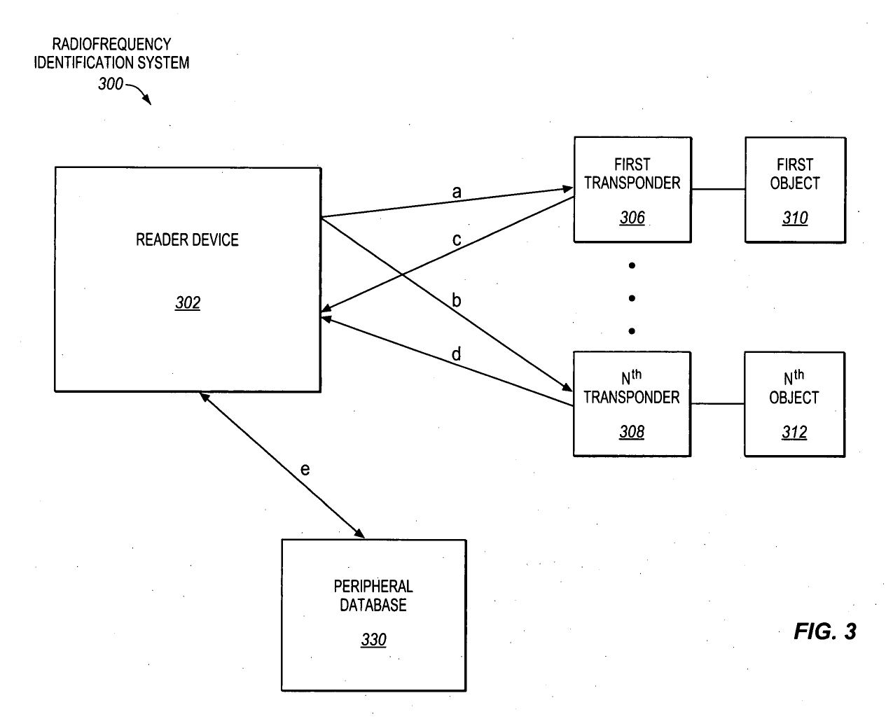

FIG. 3 is a block diagram of a radiofrequency identification system 300 having a peripheral database 330 that is accessible by the reader device, according to one or more embodiments of the invention. In one or more embodiments of the invention, the reader device may access additional information about one or more objects that are each associated with a different one of the transponders from the peripheral database.

The system includes a reader device 302, a plurality of transponders 306, 308, and a corresponding plurality of associated objects 310, 312. The components of the system of FIG. 3 may optionally have characteristics similar to those of the correspondingly named components illustrated in FIG. 1. To avoid obscuring certain concepts, the discussion below will focus primarily on the different and/or additional characteristics of the components of FIG. 3.

The system also includes the peripheral database 330. The peripheral database may be “peripheral” to the reader device, meaning that at least a portion of the peripheral database is not stored in the local memory of the reader device, but rather separated therefrom by a distance. The peripheral database may include one or more computer systems, servers, mass storage devices (e.g., tapes or arrayed disc storage), or other hardware known to be capable of implementing a database. In addition, the peripheral database may itself include multiple geographically separated servers, computer systems, or storage, which may collectively function as the peripheral database as described herein. In one or more embodiments of the invention, the peripheral database may include one or more microprocessors or other devices of Intel Corporation. Alternatively other microprocessors may optionally be used.

The reader device may be wireless coupled with, have a wired coupling with, or otherwise be capable of communicating with, the peripheral database. The coupling or communication may be bidirectional, so that information “e” may be exchanged in either, or both, directions. In one or more embodiments, the coupling or communication may be performed through a network, such as, for example, the Internet, an intranet, a local area network (LAN), or another known type of network.

The peripheral database may store additional potentially detailed information about one or more, or all, of the objects associated with the transformers. The information may include information that is different than, supplementary to, and/or more current/relevant than, data conveyed in the response signals sent from the transformers to the reader device (if there is any data sent).

To illustrate the wide variety of different types of information that are possible, consider the following illustrative examples.

In the case of a tool or instrument, examples of suitable types of information associated with the tool or instrument include, but are not limited to, maintenance status information, maintenance history information, repair person contact information, operating procedures, schematics of the tool or instrument or parts thereof, product specifications, and the like, and combinations thereof. Similar information may also be suitable for manufacturing equipment.

In the case of a manufactured product, examples of suitable types of information associated with the manufactured product include, but are not limited to, quality control status information, quality control history information, manufacturing/processing history information, material safety data sheets (MSDSs) associated with the product or materials used to make it, batch identification information, shipping information, sold/not sold status information, and the like, and combinations thereof.

In the case of a patient (e.g., human or animal), examples of suitable types of information include, but are not limited to, age, height, weight, insurance information, medical histories, drug allergies, medical procedures to be performed, contact information, and the like, and combinations thereof.

These are just a few illustrative examples. Many other examples will be apparent to those skilled in the art and having the benefit of the present disclosure. As should readily be apparent, a wide variety of different types of additional potentially detailed information may be stored in the peripheral database for an object depending upon the particular implementation.

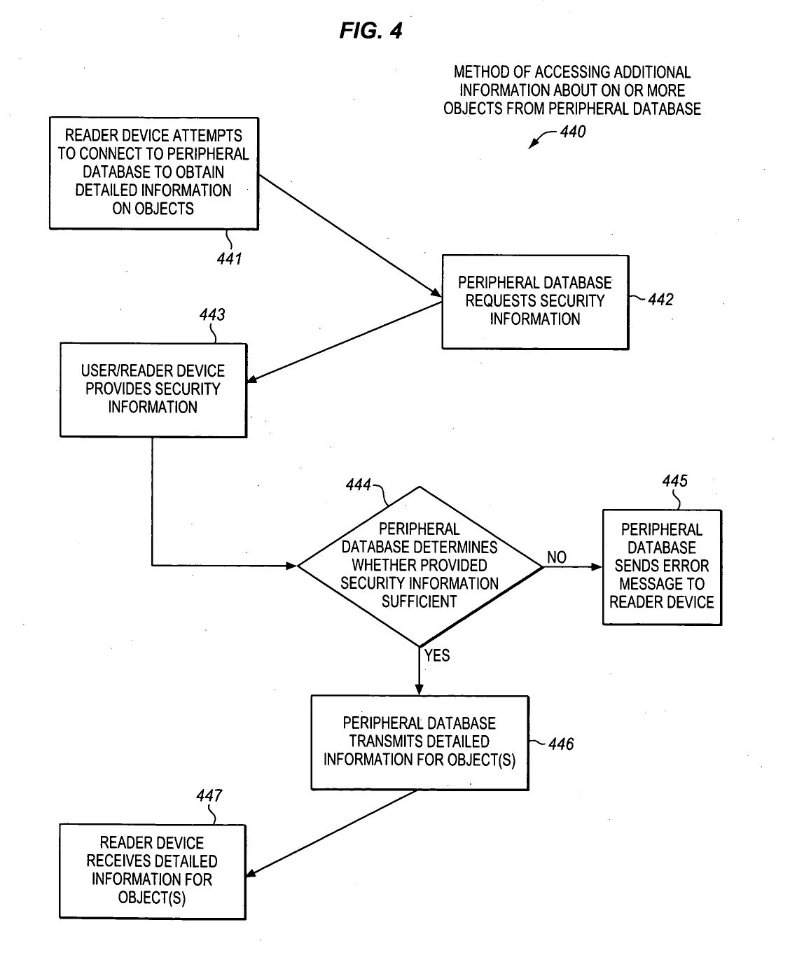

FIG. 4 is a block flow diagram of a method 440 of a reader device obtaining or accessing additional potentially detailed information about one or more objects that are each associated with a different one of the transponders from a peripheral database, according to one or more embodiments of the invention. In this method, the reader device acts as a gateway allowing a user to obtain additional potentially detailed information about objects from a peripheral database.

At block 441, the reader device may attempt to connect to the peripheral database to obtain the additional information on one or more objects. In one or more embodiments, the reader device may attempt to access the additional information responsive to the user clicking on or otherwise selecting the one or more objects corresponding to one or more of the wireless response signals in a display screen of the reader device or otherwise requesting the additional information, although other stimulus are also contemplated. In one or more embodiments, the attempt to obtain the additional information may include transmitting identifiers for each of the one or more objects to the peripheral database.

Then, the peripheral database may optionally request security information from the user and/or the reader device, at block 442. For example, the peripheral database may display a page requesting a username and password, access code, secret code, authenticating information, or the like.

Then, the user and/or the reader device may provide the security information, at block 443. For example, the user may enter the requested username and password. As another example, the security information may be stored in a cookie or other data structure on the reader device.

The peripheral database may receive the provided security information. Then, at block 444, a determination may be made whether the provided security information is correct or otherwise sufficient.

If the provided security information is not sufficient (i.e., “no” is the determination at block 444), then the peripheral database may send an invalid user or other error message to the reader device, at block 445. The error message may optionally include contact information the user may contact to attempt to obtain authorization or with questions.

Alternatively, if the provided security information is sufficient (i.e., “yes” is the determination at block 444), then the peripheral database may transmit the additional potentially detailed information for the one or more objects to the reader device, at block 446. The additional information may include the types of information previously discussed, or other information entirely.

The reader device may receive the additional information for the one or more objects it requested the additional information for, at block 447. In one or more embodiments of the invention, the additional information may be displayed or otherwise presented to the user, who may make cognitive decisions based on the additional information. As another option, in one or more embodiments of the invention, the reader device may use the additional information to perform analysis based at least in part on the additional information, as disclosed elsewhere herein. Accordingly, in one or more embodiments the reader device may include analysis logic, of the type described previously.

A particular method 440 has been shown and described to illustrate certain concepts, although the scope of the invention is not limited to this particular method. In alternate embodiments, operations may optionally be omitted from and/or added to the method. For example, the security feature associated with blocks 442, 443, 444, and 445 may optionally be omitted. As another example, the reader device may optionally store information, such as, for example, updated information associated with the responses to the interrogation, to the peripheral database. Other modifications and/or adaptations are also possible and will be apparent to those skilled in the art and having the benefit of the present disclosure.

In the description above, the peripheral database 330 has been used to store data, provide data to the reader device, and implement security functions associated with providing the data. However, in one or more embodiments of the invention, the peripheral database 330 may include a peripheral information system that includes business logic in addition to the underlying database. The peripheral information system may be capable of performing analysis beyond the type of analysis typically performed by a database. The peripheral information system may receive information from the reader device and may perform an analysis based on the information. The peripheral information system may perform any of the types of analysis described for the reader device. For example the analysis may involve determining compatibility, sufficiency for a task, etc. Typically, the peripheral information system may include greater processing capability or resources than the reader device. This may allow more extensive analysis and/or faster analysis may be performed. The results of the analysis may be returned to the reader device. As another option, in one or more other embodiments, a portion of the analysis may be performed by the reader device, and another portion of the analysis may be performed by the peripheral information system.

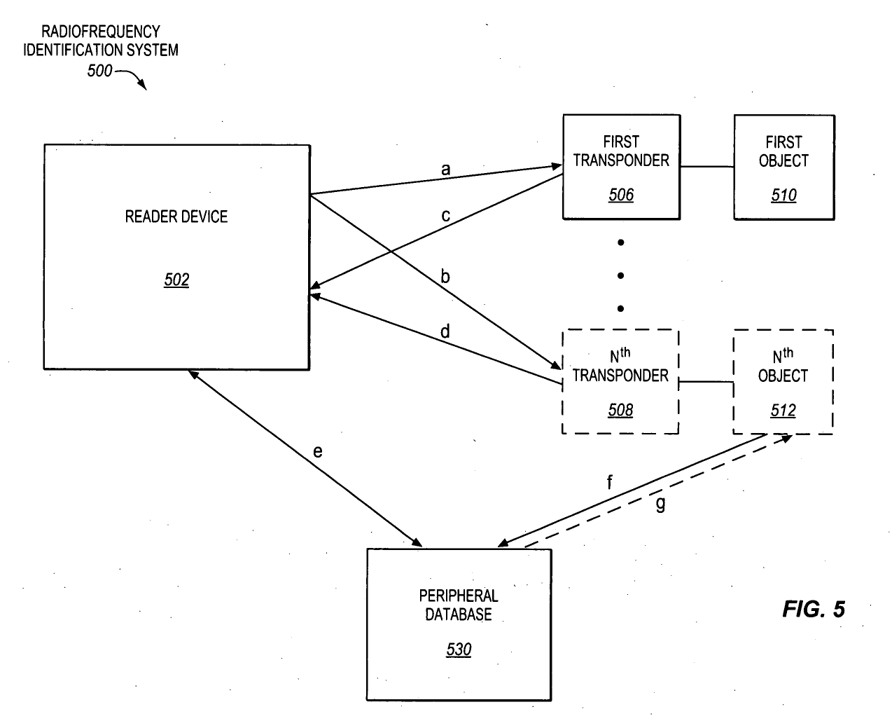

FIG. 5 is a block diagram of a radiofrequency identification system 500 having an object 512 that is capable of communicating with a peripheral database 530, according to one or more embodiments of the invention.

The system includes a reader device 502, a plurality of transponders 506, 508 and a corresponding plurality of associated objects 510, 512, and a peripheral database 530. The components of the system of FIG. 5 may optionally have characteristics similar to those of the correspondingly named components illustrated in FIG. 1 and/or FIG. 3. To avoid obscuring certain concepts, the discussion below will focus primarily on the different and/or additional characteristics of the components of FIG. 5.

The system includes an Nth object 512. In one or more embodiments of the invention, the Nth object may include a functioning electronic device. Examples of suitable electronic devices include, but are not limited to, manufacturing equipment (e.g., a semiconductor manufacturing equipment, process controllers, etc.), medical equipment (e.g., a patient monitoring system or a medical diagnostic equipment), analytical testing equipment (e.g., a chromatograph), and various other types of electronic devices.

As shown, the Nth object may be wireless coupled with, have a wired coupling with, or otherwise be capable of communicating with, the peripheral database. As one example, the object may have a standard wired network connection with the peripheral database, such as, for example, over the Internet, an intranet, a LAN, or another known type of network. As another example, the object may have a wireless transmitter and potentially a wireless receiver to connect with the peripheral database. In various embodiments of the invention, the coupling or communication may be unidirectional in either direction or bidirectional.

The Nth object may transmit or otherwise communicate information or data to the peripheral database. This is shown at “f” in the illustration. Examples of suitable different types of information that may be transmitted include, but are not limited to, status information associated with the electronic device or other object (e.g., on, off, hibernating, broken, calibrated, uncalibrated, booting up, etc.), operational results, calibration or quality control test results, information inputted into the device by a user (e.g., calibration or maintenance history information), productivity or throughput information, etc. In one particular example, an object that is malfunctioning may provide a malfunctioning status signal “f” to the peripheral database, and the peripheral database may correspondingly automatically or when requested provide information on who to contact to the reader device. These are just a few illustrative examples. Many other examples will be apparent to those skilled in the art and having the benefit of the present disclosure. The scope of the invention is not particularly limited as to the type of information.

The information or data communicated from the Nth object may potentially be stored in the peripheral database. In one or more embodiments, the peripheral database may include a peripheral information system as disclosed above, which may also perform analysis on the information or data using business logic. The information or data and/or analysis results associated with the information or data may be viewed or analyzed by users with access to the peripheral database. In one or more embodiments of the invention, the information or data may be retrieved from the peripheral database by the reader device. As before, this retrieved data may be displayed to a user of the reader device and/or used for analysis or to make determinations by the reader device.

As further shown, in one or more embodiments of the invention, the peripheral database may provide a signal to the Nth object. This is shown at “g” in the illustration.

In one or more embodiments of the invention, the signal may include a control signal. The control signal may control operation of the object. By way of example, the control signal may turn the object on, turn the object off, wake the object up from hibernation, restart the object, recalibrate the object, cause the object to sound an alarm, cause the object to start a test, cause the object to change its configuration, change a setting of the object, etc. In one or more embodiments of the invention, the reader device may request that the peripheral database provide the control signal to an electronic device of an object to change the status of the electronic device. A potential advantage of this configuration is that a user of the reader device may control the object indirectly through the peripheral database, rather than by having to directly communicate with or issue control signals to the object. This may allow a potentially simple reader device to use known or standard interfaces already available through the peripheral database to communicate with potentially heterogeneous types of objects and associated interfaces.

In the illustrated embodiment, for ease of illustration, only the Nth object is capable of communicating with the peripheral database. Commonly, some (a portion or subset) of the objects will have this capability, and other of the objects, for example the relatively simpler objects and/or the objects with the least electrical sophistication, may not have this capability. Alternatively, all (or none) of the objects may have this capability.

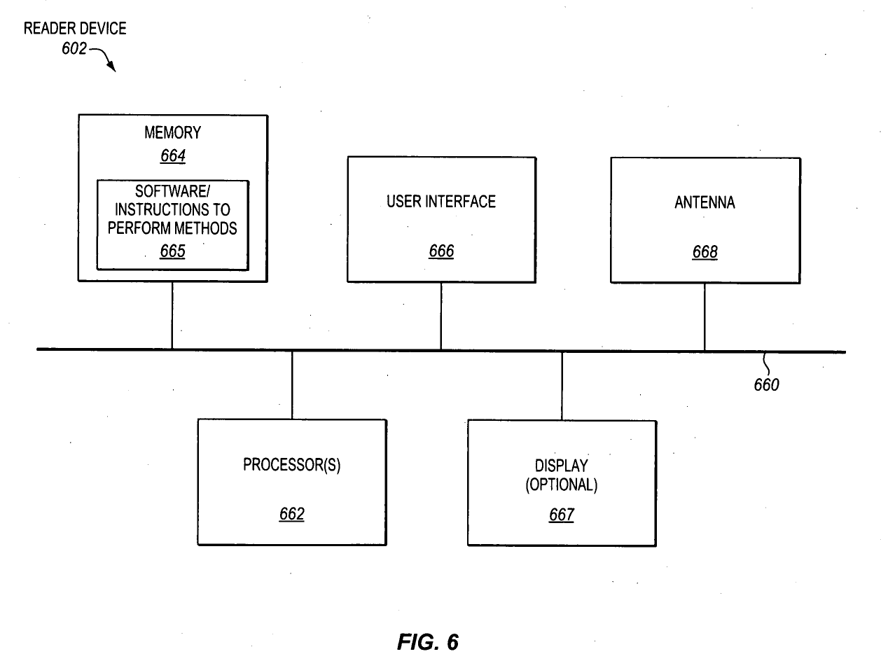

FIG. 6 is a simplified block flow diagram of an example reader device 602, according to one or more embodiments of the invention. The reader device includes one or more buses 660. The one or more buses may be used to communicate information among the other illustrated components, which are connected to, or coupled with, the one or more buses.

One or more processors 662 are coupled with the one or more buses. The one or more processors may process information, for example, by executing instructions and/or software. In one or more embodiments of the invention, the processor(s) may include one or more processor(s) available from Intel Corporation, of Santa Clara, Calif. Alternatively, other processor(s) may optionally be used.

A memory 664 is coupled with the one or more buses. The memory may include one or more different types of memory. For example, the memory may include a random access memory (RAM) or other dynamic storage device and a read only memory or other static storage device. By way of example, the ROM may store the basic input-output system (BIOS) and other static information and/or instructions, and the RAM may store information and/or instructions to be executed by the processor. Examples of suitable types of memory that are included in the reader device include, but are not limited to, static-RAM (SRAM), dynamic-RAM (DRAM), Flash memory, programmable ROM (PROM), erasable-and-programmable ROM (EPROM), electrically-erasable-and-programmable ROM (EEPROM), and combinations thereof.

Software and/or instructions 665 to perform one or more methods, according to one or more embodiments of the invention, may be stored in the memory. In one or more embodiments of the invention, the software/instructions if executed may result in the reader device performing operations including analyzing interrelationships between different types of objects that are each associated with one of a plurality of transponders for which wireless response signals have been received in response to transmitting a wireless interrogation signal. As another option, in one or more embodiments of the invention, the software/instructions if executed may result in the reader device performing operations including accessing additional information from a peripheral database about one or more objects that are each associated with a different one of the plurality of transponders for which wireless response signals have been received in response to transmitting a wireless interrogation signal.

A user interface 666 is coupled with the one or more buses. In different embodiments, the user interface may range from being relatively simple to relatively complex. For example, the user interface may include anywhere from a few keys to a full alphanumeric keyboard. In addition, in one or more embodiments, the user interface may include a mouse, trackball, cursor direction keys, or other cursor control device.

A display device 667, such as, for example, a liquid crystal display (LCD), is also coupled with the one or more buses. The display device may be used to display information and/or processing results to a user. Alternatively, the display device may be external to the reader device and coupled to the reader device, for example, by a cable or connector.

An antenna 668 is also coupled with the one or more buses. The antenna may transmit wireless signals or interrogation signals to transponders, as disclosed elsewhere herein. The antenna may also receive wireless response signals from the transponders. Alternatively, separate antennas may optionally be used for transmission and reception.

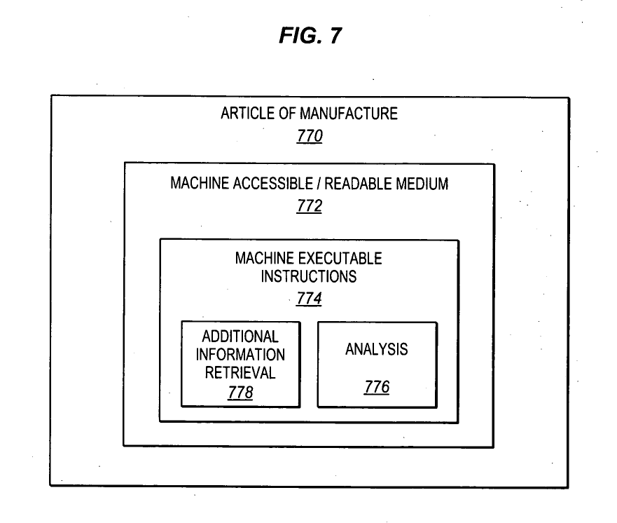

FIG. 7 is a block diagram of a program product or other article of manufacture 770, according to one or more embodiments of the invention. In various embodiments of the invention, the article of manufacture may include a dedicated data storage device (e.g., a CD-ROM) or an electronic device (e.g., a reader device having a memory).

The article of manufacture includes a machine-readable or otherwise machine-accessible medium 772. The machine accessible/readable medium may include, a mechanism that provides, for example stores, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), Flash memory, and combinations thereof.

The medium has machine-executable instructions 774. The instructions may be executed by one or more processors of a machine, one or more circuits of a machine, or otherwise executed by a machine. Suitable machines include, but are not limited to, reader devices, interrogation devices, personal digital assistants (PDAs), laptops, clinical notebooks, other computer systems, other wireless devices, and a wide variety of other devices with one or more processors, to name just a few examples.

The instructions, if executed by the machine, may result in and/or cause the machine to perform one or more of the operations or methods disclosed herein. As shown, in one or more embodiments of the invention, the instructions may include analysis instructions 776, representing one form of analysis logic as disclosed elsewhere herein. As further shown, in one or more embodiments of the invention, the instructions may include additional information retrieval instructions 778 as disclosed elsewhere herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other, for example through an intervening element or component.

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

It will also be appreciated, by one skilled in the art, that modifications may be made to the embodiments disclosed herein, such as, for example, to the configurations, functions, and manner of operation, and use, of the components of the embodiments. All equivalent relationships to those illustrated in the drawings and described in the specification are encompassed within embodiments of the invention. Where considered appropriate, reference numerals or terminal portions of reference numerals have been repeated among the figures to indicate corresponding or analogous elements, which may optionally have similar characteristics.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

What is claimed is:

1. A method comprising:
transmitting a wireless interrogation signal;
receiving corresponding wireless response signals from each of a plurality of transponders;
analyzing interrelationships between different types of objects each associated with one of the transponders.

2. The method of claim 1, wherein analyzing the interrelationships comprises analyzing mutual compatibilities of the different types of objects.

3. The method of claim 2, wherein analyzing the interrelationships comprises analyzing for dangerous interactions between the different types of objects.

4. The method of claim 3, wherein analyzing for dangerous interactions comprises analyzing for dangerous chemical interactions.

5. The method of claim 1, wherein analyzing the interrelationships comprises analyzing for sufficiency of the different types of objects to complete a given task.

6. The method of claim 5, wherein analyzing for sufficiency of the different types of objects to complete the given task comprises identifying required objects to complete the task and determining if each of the required objects are included in the different types of objects whose associated transponders responded to the interrogation signal.

7. The method of claim 5, wherein analyzing for sufficiency to complete a task comprises analyzing for sufficiency to complete a task selected from: (a) a medical procedure; and (b) a manufacture of a product.

8. The method of claim 1, further comprising:
making a determination based on the analysis; and
presenting the determination to a user.

9. The method of claim 1, further comprising, prior to analyzing, accessing additional information about one or more of the different types of objects from a peripheral database, and wherein analyzing comprises analyzing based, at least in part, on the additional information.

10. An article of manufacture comprising:
a machine-accessible medium that provides instructions that if executed result in a machine performing operations including,
analyzing interrelationships between different types of objects that are each associated with one of a plurality of transponders, wireless response signals having been received for each of the plurality of transponders in response to transmitting a wireless interrogation signal.

11. The article of claim 10, wherein analyzing the interrelationships comprises analyzing mutual compatibilities of the different types of objects.

12. The article of claim 10, wherein analyzing the interrelationships comprises analyzing for dangerous interactions between the different types of objects.

13. The article of claim 10, wherein analyzing the interrelationships comprises analyzing for sufficiency of the different types of objects to complete a given task.

14. The article of claim 10, further comprising, prior to analyzing, accessing additional information about one or more of the different types of objects from a peripheral database, and wherein analyzing comprises analyzing based, at least in part, on the additional information.

15. A method comprising:
transmitting a wireless interrogation signal;
receiving corresponding wireless response signals from each of a plurality of transponders;
accessing additional information about one or more objects that are each associated with a different one of the transponders from a peripheral database.

16. The method of claim 15, wherein accessing the additional information is responsive to a user selecting an object corresponding to one of the wireless response signals in a display of a reader device, and wherein the peripheral database is accessible by the reader device through a network.

17. The method of claim 15, wherein accessing the additional information comprises:
receiving a request for security information from the peripheral database; and
providing the requested security information to the peripheral database.

18. The method of claim 15, wherein an object is selected from a tool, an instrument, manufacturing equipment, a manufactured product, and a patient, and wherein:
if the object is selected from the tool, the instrument, and the manufacturing equipment, then the additional information comprises information associated with the object that is selected from maintenance status information, maintenance history information, repair person contact information, operating procedures, schematics of the object or parts thereof, product specifications, and combinations thereof; or
if the object is the manufactured product, then the additional information comprises information associated with the object that is selected from quality control status information, quality control history information, manufacturing/processing history information, a material safety data sheet (MSDS), batch identification information, shipping information, sold/not sold status information, and combinations thereof; or
if the object is the patient, then the additional information comprises information associated with the object that is selected from age, height, weight, insurance information, medical histories, drug allergies, medical procedures to be performed, contact information, and combinations thereof.

19. The method of claim 15, wherein accessing the additional information comprises accessing status information associated with an object comprising an electronic device, and further comprising requesting that the peripheral database provide a control signal to the electronic device to change the status of the electronic device.

20. An apparatus comprising:
a bus;
one or more processors coupled with the bus to process instructions;
an antenna coupled with the bus to transmit a wireless interrogation signal and receive wireless response signals from each of a plurality of transponders; and
a memory coupled with the bus, the memory to provide instructions that if executed by the one or more processors result in the apparatus performing operations including:
accessing additional information from a peripheral database about one or more objects that are each associated with a different one of the plurality of transponders.

21. The apparatus of claim 20, wherein accessing the additional information is responsive to a user selecting an object corresponding to one of the wireless response signals in a display of a reader device, and wherein the peripheral database is couplable with the reader device through a network.

22. The apparatus of claim 20, wherein accessing the additional information comprises accessing status information associated with an object comprising an electronic device, and further comprising requesting that the peripheral database provide a control signal to the electronic device to change the status of the electronic device.
